(19) United States
(12) Patent Application Publication
(10) Pub. No.: US 2008/0280647 A1
(43) Pub. Date: Nov. 13, 2008

(54) Integrated telecommunications architecture for extended operability

(76) Inventor: Sam Wasserman, Brooklyn, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/800,907

(22) Filed: May 8, 2007

(51) Int. Cl. H04B 1/38

(52) U.S. Cl. 455/557

(57) ABSTRACT

The embodiments of the invention allow a mobile phone that is part of a wireless network, access to a landline telephone network and utilize mobile phone features across a landline telephone network to another landline or mobile phone. Furthermore, embodiments of the invention provide a method and system for utilizing mobile telephone features with a landline telephone. These features include, but are not limited to, text messaging, voice communication, contact information, image messaging, video messaging, and data transfer.

### BACKGROUND OF THE INVENTION

Landline telephone and mobile phone customers are constantly challenged by taking advantage of features of one phone for use with the other. For example, many mobile phone users have contact phone information stored in their mobile phone memory. In many rural and remote areas, mobile phone users cannot utilize this feature because they have no access to the mobile phone network. However, they do have access to a landline telephone. Thus, a user may want to use the contact information feature in the mobile phone when using a landline telephone, but must manually access and enter the contact phone number from the mobile phone into the landline phone. Similarly, most landline phones do not have the capability to send or receive text messages. Text messaging across a mobile phone network has become a popular feature and many customers would like it extended to landline telephones. Thus, many mobile phone users would like to use their mobile phones to text message across a landline telephone network to a landline telephone.

### BRIEF SUMMARY OF THE INVENTION

The embodiments of the invention allow a mobile phone that is part of a wireless network, access to a landline telephone network and utilize mobile phone features across a landline telephone network to another landline or mobile phone. Furthermore, embodiments of the invention provide a method and system for utilizing mobile telephone features with a landline telephone. These features include, but are not limited to, text messaging, voice communication, contact information, image messaging, video messaging, and data transfer.

### BRIEF DESCRIPTION OF THE SEVERAL VIEWS OF THE DRAWING(S)

While the appended claims set forth the features of the present invention with particularity, the invention and its advantages are best understood from the following detailed description taken in conjunction with the accompanying drawings, of which:

FIG. 1 is a general overview of the operation of a system contemplated by an exemplary embodiment;

FIG. 2 is a flow diagram illustrating the steps in data messaging between a mobile phone and a landline line telephone, in accordance with an exemplary embodiment;

FIG. 3 is a general overview of the operation of a system contemplated by an exemplary embodiment;

FIG. 4 is a functional block diagram of a mobile phone, in accordance with an exemplary embodiment;

FIG. 5 is a functional block diagram of a mobile phone, in accordance with an exemplary embodiment;

FIG. 6 is a general overview of the operation of a system and a function block diagram of a system contemplated by an exemplary embodiment;

FIG. 7 is a flow diagram illustrating the steps in data messaging from a mobile phone to a landline line telephone, in accordance with an exemplary embodiment;

FIG. 8 is a flow diagram illustrating the steps in data messaging from a landline telephone to a mobile phone, in accordance with an exemplary embodiment; and

FIG. 9 is a general overview of the operation of a system contemplated by an exemplary embodiment.

### DETAILED DESCRIPTION OF THE INVENTION

The embodiments of the invention allow a mobile phone that is part of a wireless network, access to a landline telephone network and utilize mobile phone features across a landline telephone network to another landline or mobile phone. Furthermore, embodiments of the invention provide a method and system for utilizing mobile telephone features with a landline telephone. These features include, but are not limited to, text messaging, voice communication, contact information, image messaging, video messaging, and data transfer.

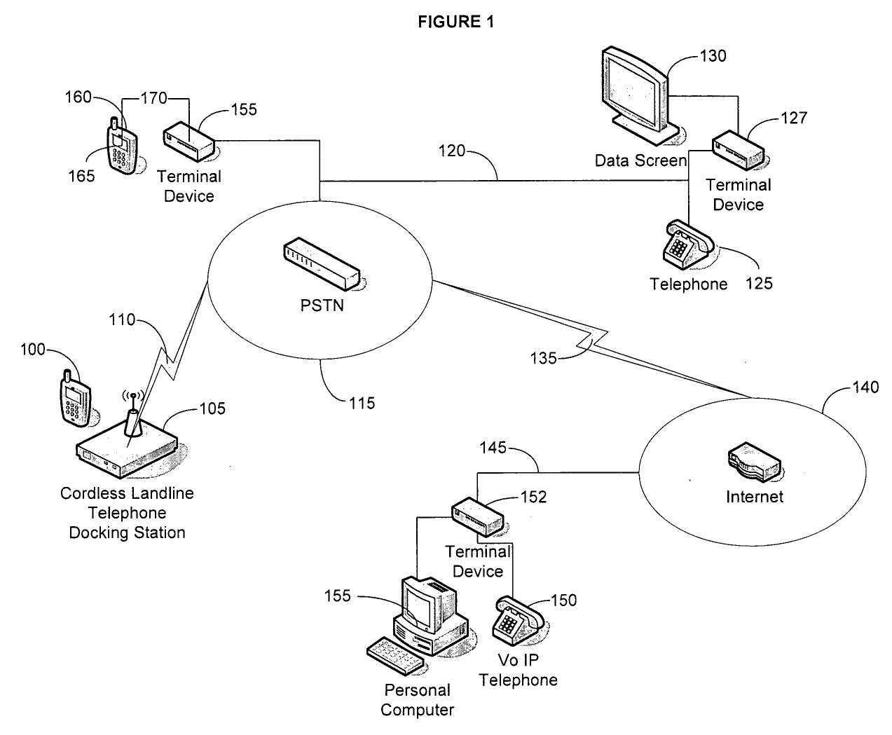

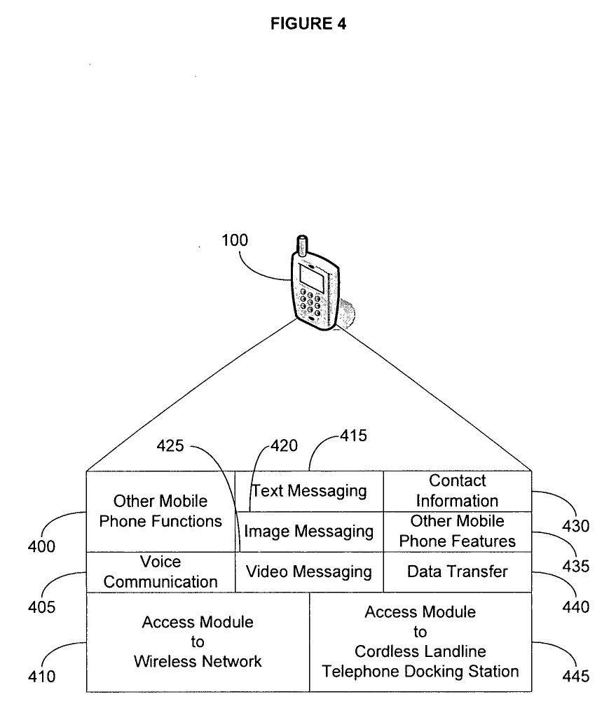

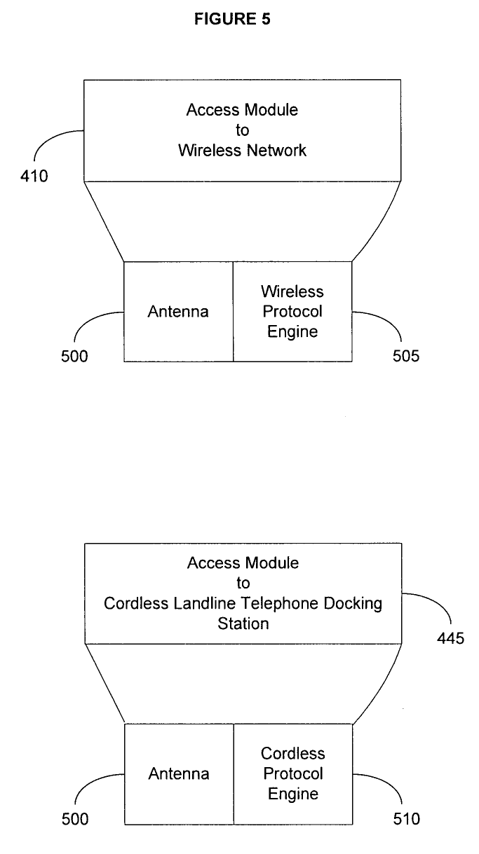

FIG. 1 is a general overview of the operation of a system contemplated by an exemplary embodiment. A mobile phone (100) which is part of a wireless, cellular, or mobile phone network, gains access to a public switched telephone network (“PSTN”) (115) through a cordless landline telephone docking station (105). A mobile phone's (100) capability to gain access to the PSTN (115) will be further discussed in describing FIGS. 4-5. After gaining access to the PSTN (115), a mobile phone is perceived by the cordless landline telephone docking station (115), a landline telephone network, and potential destination landline telephone (125 and 150) as a cordless landline telephone. However, a mobile phone (100) can still access all mobile phone features when accessing a landline network. Thus, a mobile phone (100) has use of contact information stored in a mobile phone (100) as well as a data messaging capability found within it. Consequently, a mobile phone (100) can then transmit data messages through a cordless telephone docking station (105), communication links (110, 120) and PSTN (115) to a terminal device (127) attached to a destination landline telephone (125) that displays the messages on a data screen (130). Data messages may be in the form of voice communication, text messaging, image messaging, video messaging, or any other data transfer. Alternatively, a destination telephone for data messages may be a Voice over IP (“VoIP”) landline telephone (150). In such a scenario, data messages travel across a PSTN (115) across a communication link (135), through the Internet (140), another communication link (145) to a terminal device (152) attached to a personal computer (155) and a VoIP telephone (150). The terminal devices (127 and 152) are not limited to being stand-alone devices but can also be implemented as components, in software, hardware, or firmware, to a personal computer (155), VoIP telephone (150), landline telephone (125), data screen (130), or some other device. Another landline destination phone could be a cordless landline phone (160) wirelessly connected (170) to a terminal device (155). Any data messages received from the mobile phone (100) are displayed to the cordless landline telephone (160) on its screen (165). Furthermore, any destination landline phone, be it a traditional landline phone (125), a VoIP phone (150), or a cordless phone (160), is capable of sending a data message to a mobile phone (100) on the landline telephone network.

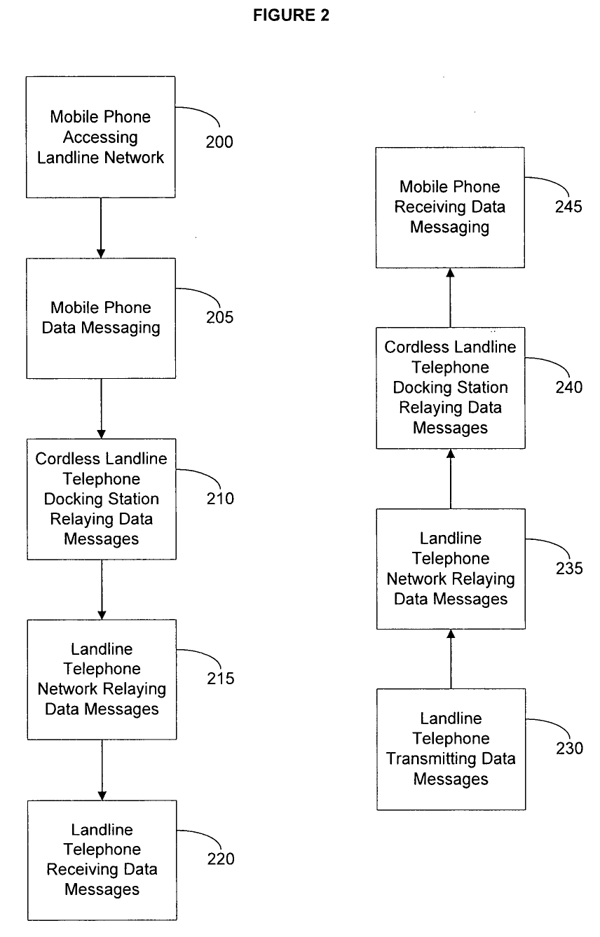

FIG. 2 is a flow diagram illustrating the steps in data messaging between a mobile phone and a landline line telephone, in accordance with an exemplary embodiment. A step in data messaging from a mobile phone to a landline telephone is for a mobile phone to gain access to the landline network (200). There are several different ways a mobile phone accesses a landline network that may include, but are not limited to: replacing a microprocessor within the mobile phone (similar to replacing its Subscriber Identity Module (“SIM”) card); switching a mode of a mobile phone from a wireless network access mode to a landline telephone network access mode; entering an alphanumeric code to access a landline telephone network; or any other accessing means. Another step allows for the mobile phone to data message (205) across the landline telephone network, through the cordless landline telephone docking station to a landline telephone. As mentioned previously, data messages may be in the form of voice communication, text messaging, image messaging, video messaging, or any other data transfer. Another step in the data messaging flow diagram has the cordless landline telephone docking station relaying the data messages (210) from a mobile phone, through a landline telephone network, to a landline telephone. Another step in the flow diagram has a landline network relaying data messages (215) from a mobile phone, through a cordless landline telephone docking station, to a landline telephone. A landline telephone network can be any network such as a packet switched, public switched telephone wireless, broadband, local area, wide area, data, or any other network. Another step in the flow diagram has a destination landline telephone receiving data messages (220) from a mobile phone, through a cordless landline telephone docking station and landline telephone network. Of course, an embodiment of the invention includes a landline telephone data messaging to a mobile phone having access to the landline telephone network. One step in this embodiment allows a landline telephone to transmit data messages to a mobile phone across the landline telephone network (230). Another step provides a landline telephone network to relay data messages from the landline telephone to a cordless landline telephone docking station (235). Another step provides a cordless landline telephone docking station to relay data messages to a mobile phone having access to a landline telephone network (240). Another step provides for a mobile phone having access to a landline telephone network to receive the data messages from a cordless landline telephone docking station (245).

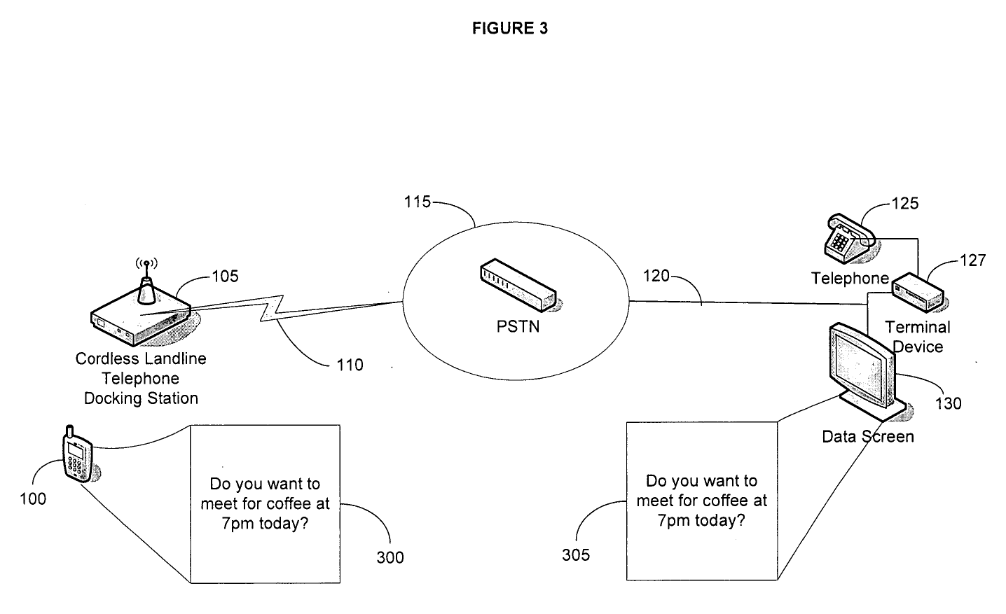

FIG. 3 is a general overview of the operation of a system contemplated by an exemplary embodiment. FIG. 3 shows an embodiment where a mobile phone (100) gains access to a landline telephone network, namely a PSTN (115), through a cordless landline telephone docking station (105). The mobile phone (100) then enters and transmits a text message (300) to a landline telephone (125) across the PSTN (115). The landline telephone's (125) terminal device (127) displays the text message (305) on a data screen (130).

FIG. 4 is a functional block diagram of a mobile phone, in accordance with an exemplary embodiment. FIG. 4 shows a functional block diagram illustrating some, but not all, of the functions of a mobile phone (100) in an embodiment of the invention. These functions and features include a module for accessing either a wireless network (410) or a cordless landline telephone docking station (445). The mobile phone (100) also contains several functions it can use after gaining access to a landline telephone network, through a cordless landline telephone docking station. These features include voice communication (405), text messaging (415), image messaging (420), video messaging (425), contact information (430), data transfer (440), and any other mobile phone features (435). In addition, the mobile phone (100) has several other mobile phone functions (400).

FIG. 5 is a functional block diagram of a mobile phone, in accordance with an exemplary embodiment. FIG. 5 shows some, but not all, of the detail functional components of both the wireless network access module (410) and the access module to the cordless landline telephone docking station (445). In the wireless network access module (410), there is an antenna (500) and a wireless protocol engine (505). The antenna (500) transmits and receives signals between the mobile phone and the wireless network. The wireless protocol engine (505) encapsulates or de-capsulates data messages to and from the mobile phone (100) in a wireless protocol format. Similarly, in the access module of the cordless landline telephone docking station (445), there is an antenna (500) and a cordless protocol engine. In this embodiment, there is one antenna (500) to access both the wireless network and the cordless landline telephone docking station. Alternative embodiments may have more than one antenna to allow the mobile phone (100) to gain access to several networks. The cordless protocol engine (510) encapsulates and de-capsulates data messages to and from the mobile phone (100) in a cordless telephone protocol format.

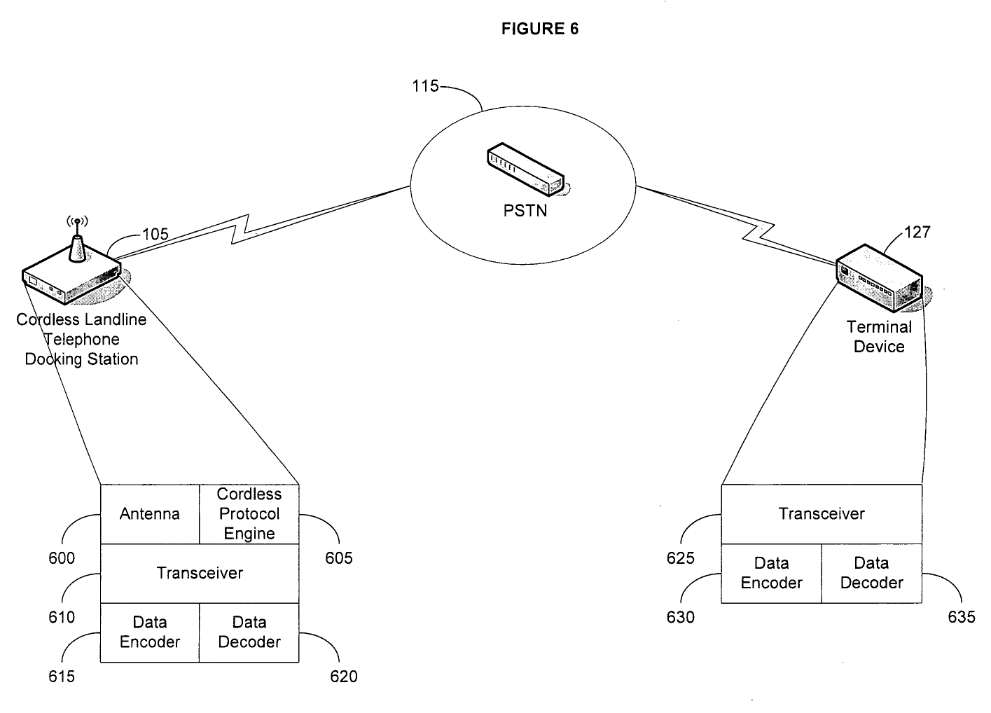

FIG. 6 is a general overview of the operation of a system and a function block diagram of a system contemplated by an exemplary embodiment. FIG. 6 shows some, but not all, of the functional components of both a cordless landline telephone docking station (105) and a terminal device (127) set in an embodiment. Some functional components contained in the cordless landline telephone docking station (105) include an antenna (600), a cordless protocol engine (605), a transceiver (610), a data encoder (615), and a data decoder (620). The antenna (600) transmits and receives signals between the mobile phone (100) and the cordless telephone landline docking station (105). A cordless protocol engine encapsulates or de-capsulates data messages in a cordless telephone protocol format. A transceiver transmits and receives data messages between a data encoder (615) or a data decoder (620), and a mobile phone (100). A data encoder (615) encodes data messages between a mobile phone (100) through a cordless landline telephone docking station (105) and a landline telephone network. A data decoder (620) decodes data messages between a mobile phone (100) through a cordless landline telephone docking station (105) and landline telephone network. The coding format could be any coding format (e.g. facsimile coding, e-mail coding, etc.) to convey messages across a landline telephone network.

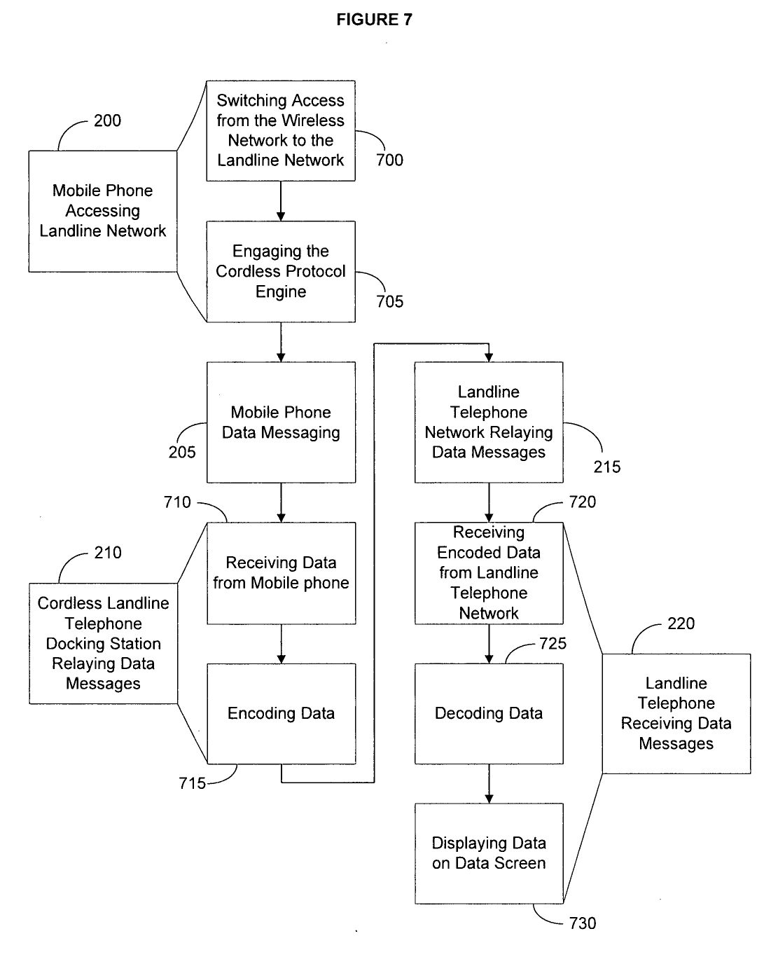

FIG. 7 is a flow diagram illustrating the steps in data messaging from a mobile phone to a landline telephone, in accordance with an exemplary embodiment. FIG. 7 provides more detailed steps in the method of data messaging from a mobile phone (100) to a landline telephone (125) than described in FIG. 2. In FIG. 2, there was a step where a mobile phone (100) gains access to a landline network (200). There are at least two further sub-steps to gain access to a landline network (200). One sub-step is to have a mobile phone (100) switch from accessing a wireless (e.g. cellular, mobile, etc.) to a landline network (700). Another sub-step is to have a mobile phone (100) engage a cordless protocol engine (705) to transmit data in a cordless telephone format. Another step, as in FIG. 2, is to have the mobile phone data message (205) to landline phone, through a cordless landline telephone docking station (105) and a landline telephone network. Another step that can be broken into at least two sub-steps is the cordless landline telephone docking station relaying messages from a mobile phone (100) to a landline telephone network (210). One sub-step is receiving data from a mobile phone (710). Another sub-step is encoding the data into a proper format to travel across a landline telephone network and be received by a destination landline telephone (715). The coding format could be any coding format (e.g. facsimile coding, e-mail coding, etc.) to convey messages across a landline telephone network. Another step in the flow diagram pictured in FIG. 7 illustrates the landline telephone network relaying data messages (215) from the cordless landline telephone docking station to the destination landline telephone. Another step, as in FIG. 2, is the destination landline telephone receiving data message from the landline telephone network (220). This step can be broken into at least three sub-steps. One of these sub-steps is receiving the encoded data from the landline telephone network (720). Another sub-step is decoding the data (725). Another sub-step is displaying the decoded data on a data screen (730).

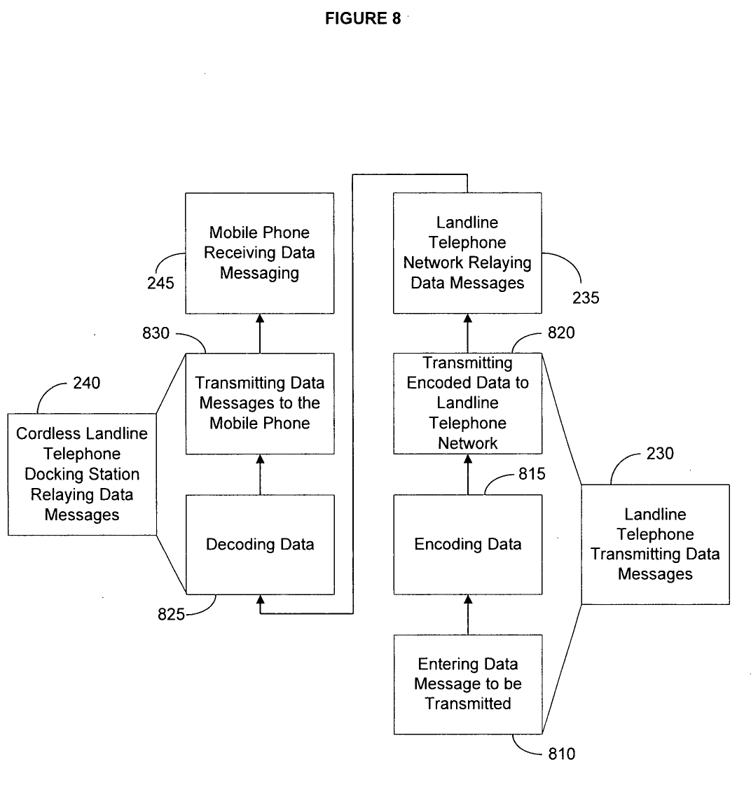

FIG. 8 is a flow diagram illustrating the steps in data messaging from a landline telephone to a mobile phone, in accordance with an exemplary embodiment. FIG. 8 provides more detailed steps in data messaging from a landline telephone (165, 125, and 150) to a mobile phone (100) than described in FIG. 2. The step of a landline telephone transmitting data messages (230) can be broken into at least three sub-steps. These include entering a data message to be transmitted (810), encoding data with a terminal device (815), and transmitting encoded data to a landline telephone network (820). Another step in the data messaging provides for the landline telephone network to relay data messages from a landline telephone to a cordless landline telephone docking station (235). A next step provides for a cordless landline telephone docking station to relay data messages to a mobile phone (240). However, this step can be broken into at least two sub-steps that include, decoding data messages (825), and transmitting data messages to a mobile phone (830). Another step provides for a mobile phone to receive data messages (245).

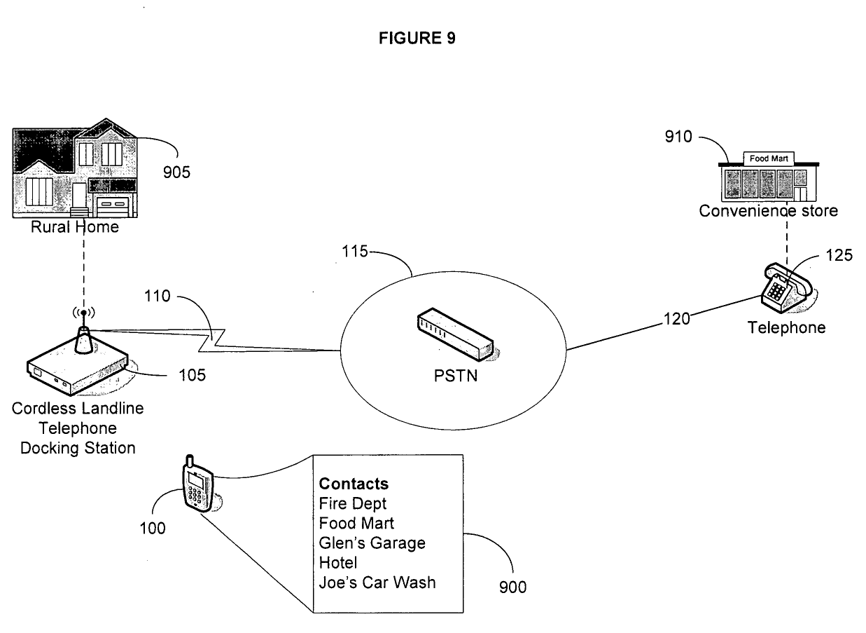

FIG. 9 is a general overview of the operation of a system contemplated by an exemplary embodiment. FIG. 9 illustrates a mobile phone taking advantage of some features of a landline telephone network. In particular, a mobile phone is limited in using its features to places where it has access to a wireless a network. Instead, by gaining access to the landline telephone network in places with limited access to a wireless network, a mobile phone can still utilize its features. For example, a mobile phone user may be located in a rural home (905) without access to a wireless network. However, the rural home (905) is connected to a landline telephone network (115). By gaining access to a landline telephone network (115), a mobile phone user takes advantage of the omnipresence of the PSTN. A mobile phone user can then utilize mobile phone features such as (but not limited to) accessing contact information (900) to call such places as a convenient store (910).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A communication system capable of sending and receiving data messages between a mobile phone and a landline phone comprising:
a mobile telephone capable of accessing the landline line network through a cordless landline telephone docking station;
a cordless landline telephone docking station capable of relaying data messages between a mobile phone and a landline telephone across the landline telephone network;
a landline network able to relay data messages across a voice channel of the landline telephone network between a mobile phone and a landline telephone docking station, through a cordless docking station;
a landline telephone connected to the landline telephone network, capable of sending and receiving data messages to and from a mobile phone, through a cordless landline telephone docking station, across the voice channel of the landline telephone network; and
a data screen connected to a landline telephone, displaying data messages from the mobile phone.

2. A communication system according to claim 1, wherein the mobile phone can use all its mobile phone features after gaining access to the public switched telephone network.

3. A mobile phone feature according to claim 2, selected from the group consisting of text messaging, voice communication, contact information, image messaging, video messaging, and data transfer.

4. A landline telephone network according to claim 1, selected from the group consisting of the a packet switched network, a public switched telephone network, a wireless network, a broadband network, a local area network, a wide area network, and a data network.

5. A mobile phone capable of accessing the landline telephone network according to claim 1, selected from the group consisting of replacing a microprocessor within the mobile phone, switching a mode of the mobile phone, entering an alphanumeric code into the mobile phone to access the landline telephone network through a cordless telephone landline docking station.

6. A mobile phone according to claim 1, wherein the mobile phone comprises:
a voice communication module;
a text messaging module;
a image messaging module;
a video messaging module;
a contact information module;
a data transfer module;
a wireless network access module;
a cordless landline telephone docking station access module;
a module that performs other mobile phone functions; and
a module that performs other mobile phone features.

7. A wireless network access module according to claim 6, wherein the wireless network access module comprises:
an antenna to transmit and receive signals between the mobile phone and the wireless network; and
a wireless protocol engine to encapsulate or de-capsulate the data messages in a wireless protocol format.

8. A cordless landline telephone docking station access module according to claim 6, wherein the cordless landline telephone docking station access module comprises:
an antenna to transmit and receive signals between the mobile phone and the cordless telephone landline docking station; and
a cordless protocol engine to encapsulate or de-capsulate the data messages in a cordless telephone protocol format.

9. A communication system according to claim 1, further comprising a terminal device wherein the terminal device comprises:
a transceiver to transmit and receive messages between data encoder or a data decoder and a data screen;
a data encoder to encode data messages between a mobile phone and a landline telephone; and
a data decoder to decode data messages between a mobile phone and a landline telephone.

10. A cordless telephone landline docking station according to claim 1, wherein the cordless telephone landline docking station comprises:
an antenna to transmit and receive signals between the mobile phone and the cordless telephone landline docking station;
a cordless protocol engine to encapsulate or de-capsulate the data messages in a cordless telephone protocol format;
a transceiver to transmit and receive messages between a data encoder or a data decoder, and a mobile phone;
a data encoder to encode data messages between a mobile phone and a landline telephone network; and
a data decoder to decode data messages between a mobile phone and landline telephone network.

11. A method for data messaging between a mobile phone and a landline telephone comprising the steps of:
a mobile phone accessing the landline telephone network through a cordless landline telephone docking station;
a cordless landline telephone docking station relaying data messages between a mobile phone and a landline telephone network;
the landline telephone network relaying data messages across a voice channel of the landline telephone network between a mobile phone and a landline telephone; and
a landline telephone connected to the landline telephone network, sending and receiving data messages to and from a mobile phone.

12. Mobile phone data messaging according to claim 11, selected from the group consisting of text messaging, voice communication, image messaging, video messaging, and data transfer.

13. A method for mobile phone data messaging according to claim 11, between a mobile phone and a landline telephone further comprising the steps of:
switching access from a wireless network to a landline network;
engaging a cordless protocol engine to encapsulate or de-capsulate the data messages into and from a correct cordless telephone protocol format;
encoding data messages between a mobile phone and a landline telephone;
decoding data messages between a mobile phone and a landline telephone; and
displaying data messages on a data screen.

14. A landline telephone network according to claim 11, selected from the group consisting of the a packet switched network, a public switched telephone network, a wireless network, a broadband network, a local area network, a wide area network, and a data network.

15. A mobile phone capability of accessing the landline telephone network according to claim 11, selected from the group consisting of replacing a microprocessor within the mobile phone, switching a mode of the mobile phone, entering an alphanumeric code into the mobile phone to access the landline telephone network through a cordless telephone landline docking station.

16. A method of utilizing the contact information feature on a mobile phone connected to landline network.
